(19) United States
(12) Patent Application Publication
(10) Pub. No.: US 2024/0394622 A1
(43) Pub. Date: Nov. 28, 2024

(54) DEMAND FORECASTING TOOL FOR FOOD ESTABLISHMENTS

(71) Applicant: SAP SE, Walldorf (DE)

(72) Inventors: Sachin B S, Bangalore (IN); Sreevishnu A B, Kerala (IN); Prasanna Bhat Mavinakuli, Sadar Tq. (IN)

(21) Appl. No.: 18/201,958

(22) Filed: May 25, 2023

(51) Int. Cl. G06Q 10/0631; G06Q 10/04; G06Q 50/12

(52) U.S. Cl. CPC G06Q 10/06315; G06Q 10/04; G06Q 50/12

(57) ABSTRACT

Example methods and systems are directed to demand prediction with respect to food items. First user data and second user data of a food establishment are accessed. The first user data includes a sequence of first data points for an observed period and the second user data includes a second data point for a prediction period. The first user data and the second user data are enriched with complementary feature values to generate a first input data set and a second input data set, respectively. A multi-input machine learning model generates a predicted value of a target variable for the prediction period. The multi-input machine learning model comprises a first component that processes the first input data set and a second component that processes the second input data set. Output data including the predicted value of the target variable is presented at a user device.

### TECHNICAL FIELD

The subject matter disclosed herein generally relates to demand forecasting technology. Specifically, but not exclusively, the present disclosure addresses systems and methods that leverage machine learning to generate food item-related predictions.

### BACKGROUND

Matching supply and demand in the food industry is a critical task, especially when a food establishment offers perishable food items. Overestimating demand can result in losses due to food spoilage or over-staffing, while underestimating demand can lead to missed opportunities or customer dissatisfaction.

The demand for food items offered by a food establishment can vary significantly from day to day, depending on various factors, such as the time of year, weather conditions, events in the geographic area, special offers, and competitor activities. Additionally, some food items require preparation on short notice. When considering these and other relevant factors, predicting future demand for food items can be a complex exercise. This complexity can be particularly challenging for smaller food establishments, like restaurants, cafes, or cafeterias.

### BRIEF DESCRIPTION OF THE DRAWINGS

Some embodiments are illustrated by way of example and not limitation in the figures of the accompanying drawings. In the drawings, which are not necessarily drawn to scale, like numerals may describe similar components in different views or examples. To identify the discussion of any particular element or act more easily, the most significant digit or digits in a reference number refer to the figure number in which that element is first introduced.

FIG. 1 is a diagrammatic representation of a network environment suitable for food item demand prediction, according to some examples.

FIG. 2 is a block diagram of a food item demand prediction system, according to some examples.

FIG. 3 diagrammatically illustrates training and use of a machine learning program, according to some examples.

FIG. 4 is a flowchart illustrating operations of a method suitable for training a machine learning model to generate food item demand predictions, according to some examples.

FIG. 5 diagrammatically illustrates a linked sequence of training data sets, according to some examples.

FIG. 6 diagrammatically illustrates a machine learning model architecture, according to some examples.

FIG. 7 is a flowchart illustrating operations of a method suitable for food item demand prediction, according to some examples.

FIG. 8 diagrammatically illustrates the generation of food item demand predictions, according to some examples.

FIG. 9 is a block diagram showing a software architecture for a computing device, according to some examples.

FIG. 10 is a block diagram of a machine in the form of a computer system, according to some examples, within which instructions may be executed for causing the machine to perform any one or more of the methodologies discussed herein.

### DETAILED DESCRIPTION

Example methods and systems are directed to machine learning models that generate food item-related demand predictions. As used herein, the term “machine learning model” (or simply “model”) may refer to a single, standalone model, or a combination of models (or a combination of networks). The term may also refer to a system, component or module that includes a machine learning model together with one or more supporting or supplementary components that do not necessarily perform machine learning tasks or operations.

As used herein, the term “food item” refers to any edible substance or product that is consumed, or can be consumed, by humans or animals. This may include whole foods, processed foods, beverages, condiments, and supplements. Specifically, but not exclusively, a food item may be a perishable item prepared by a food establishment using several ingredients or raw materials, and that is typically prepared on a “made to order basis,” or based on expected demand for a particular day or period.

As used herein, the term “food establishment” refers to any facility or business involved in the preparation, sale, distribution, or service of food items for human or animal consumption. Examples of food establishments include, but are not limited to, restaurants, cafes, bars, bakeries, catering services, food trucks, grocery stores, hotels, supermarkets, delis, canteens, and institutional food services. A single food establishment may be involved in multiple individual facilities or business, e.g., a single food establishment may operate multiple restaurant outlets.

A food establishment may have a need for an automated system suitable for predicting demand with respect to one or more food items prepared, sold, or distributed by the food establishment. Machine learning models are applications that provide computer systems the ability to perform tasks, without explicitly being programmed, by making inferences based on patterns found in the analysis of data. Machine learning explores the study and construction of algorithms, also referred to herein as models, that may learn from existing data and make predictions about new data. In some examples, a machine learning model is employed to provide automated food item demand prediction functionality.

In some examples, a demand prediction system accesses first user data and second user data of a food establishment. The first user data may include a sequence of first data points for an observed period. Each first data point comprises an observed value of a target variable and values of one or more establishment input features. In some examples, each data point includes data relating to a specific day, e.g., the observed period may be a month, and the sequence of first data points may relate to the sequence of days within that month.

The target variable relates to one or more food items. In some examples, the target variable is a number of food items sold or consumed in a particular food item category or of a particular food item type. Accordingly, observed values of the food establishment may include food item sales data.

The first user data may be enriched to obtain a first input data set for a machine learning model. In some examples, the first user data is, for each first data point, enriched using values of a plurality of complementary features corresponding to the first data point. Automated enrichment tools are described that may reduce user input requirements and improve accuracy of a computerized prediction system.

The second user data may include one or more second data points for a prediction period. The prediction period may be a future period for which the target variable is to be predicted, e.g., a next day or a next week. A second data point may comprise a value of each of the establishment input features for the prediction period. The second user data may be enriched to obtain a second input data set for the machine learning model. In some examples, the second user data is enriched using values of the plurality of complementary features corresponding to the (or each) second data point. An auto-enrichment function, e.g., an auto-enrichment function of an online data aggregator component, may be invoked by the system to enrich the first user data or the second user data.

The machine learning model may generate, based on the first input data set and the second input data set, a predicted value of the target variable for the prediction period. In some examples, the machine learning model is a multi-input machine learning model that includes a first component that processes the first input data set and a second component that processes the second input data set. Each of the first component and the second component may include one or more subcomponents or one or more layers. The multi-input machine learning model may be a parallel input machine learning model in which the first component and the second component separately process the first input data and the second input data, respectively. Outputs of the first component and the second component may be combined to generate the predicted value of the target variable.

The machine learning model may incorporate a Recurrent Neural Network (RNN), enabling accurate time series-based predictions and allowing a predicted value for a first prediction period to be fed into the machine learning model to facilitate predictions for second and subsequent prediction periods. In some examples, the first predicted value is automatically provided as input to the multi-input machine learning model to generate a second predicted value for a second prediction period that follows the first prediction period.

Example methods and systems are directed to training of a machine learning model based on a linked sequence of training data sets. Each training data set may include training data covering a respective training data period (e.g., a respective month). Examples of the present disclosure enable flexible and customizable linking or adjustment of sequences of training data sets for model training or retraining.

In some examples, an end-to-end, holistic solution is provided that can be easily accessed and operated by a user. As mentioned, it may be challenging to predict food item demand using conventional techniques, e.g., due to the large number of variables a food establishment has to consider. A demand prediction system as described herein may address or alleviate this challenge by performing better than systems relying on manual predictions, or less complex sets of variables. For example, a demand prediction system as described herein may be more accurate and require less human input or intervention, providing an improved technological tool useful for day-to-day management of a food establishment. A demand prediction system as described herein may also be more easily scalable than conventional systems.

Another technical challenge associated with conventional techniques is that such techniques may lack the ability to respond to changes in variables, such as customer behavior or weather patterns, over time. Examples disclosed herein may address or alleviate this challenge by providing a user-friendly and flexible technological tool that combines historic and future data to make accurate predictions, including automatic data enrichment. Examples disclosed herein may also address or alleviate this challenge by enabling retraining of a demand prediction model at regular intervals through data set connections and sequence definitions.

When the effects in this disclosure are considered in aggregate, one or more of the methodologies described herein may obviate a need for certain efforts or resources that otherwise would be involved in demand forecasting systems. Computing resources used by one or more machines, databases, or networks may be more efficiently utilized or even reduced, e.g., as a result of more accurate predictions, automated operations, enhanced scalability, or integration of tools. Examples of such computing resources may include processor cycles, network traffic, memory usage, graphics processing unit (GPU) resources, data storage capacity, power consumption, and cooling capacity.

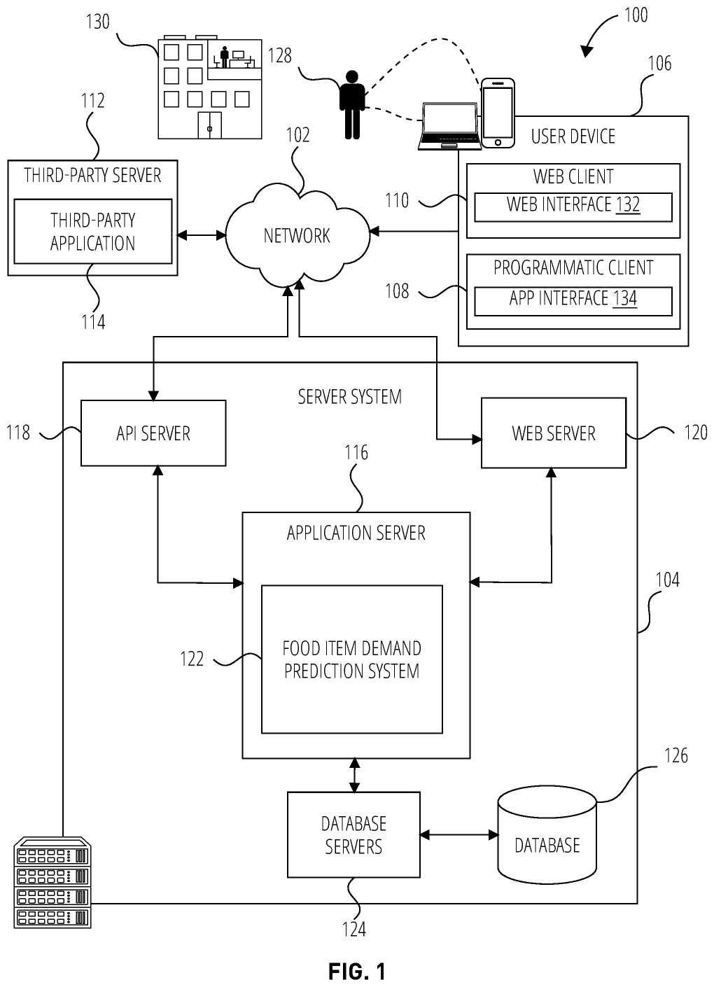

FIG. 1 is a diagrammatic representation of a networked computing environment 100 in which some examples of the present disclosure may be implemented or deployed. One or more servers in a server system 104 provide server-side functionality via a network 102 to a networked device, in the example form of a user device 106 that is accessed by a user 128. A web client 110 (e.g., a browser) or a programmatic client 108 (e.g., an “app”) may be hosted and executed on the user device 106.

An Application Programming Interface (API) server 118 and a web server 120 provide respective programmatic and web interfaces to components of the server system 104. A specific application server 116 hosts a food item demand prediction system 122, which includes components, modules, or applications.

The user device 106 can communicate with the application server 116, e.g., via the web interface supported by the web server 120 or via the programmatic interface provided by the API server 118. It will be appreciated that, although only a single user device 106 is shown in FIG. 1, a plurality of user devices may be communicatively coupled to the server system 104 in some examples. For example, multiple users associated with a food establishment 130 may access the food item demand prediction system 122 via respective user devices. Further, while certain functions are described herein as being performed at either the user device 106 (e.g., web client 110 or programmatic client 108) or the server system 104, the location of certain functionality either within the user device 106 or the server system 104 may be a design choice. For example, it may be technically preferable to deploy particular technology and functionality within the server system 104 initially, but to migrate this technology and functionality to a programmatic client at a later stage, e.g., when the user device 106 has sufficient processing capacity.

The application server 116 is communicatively coupled to database servers 124, facilitating access to one or more information storage repository, e.g., a database 126. In some examples, the database 126 includes storage devices that store information to be processed or transmitted by the food item demand prediction system 122.

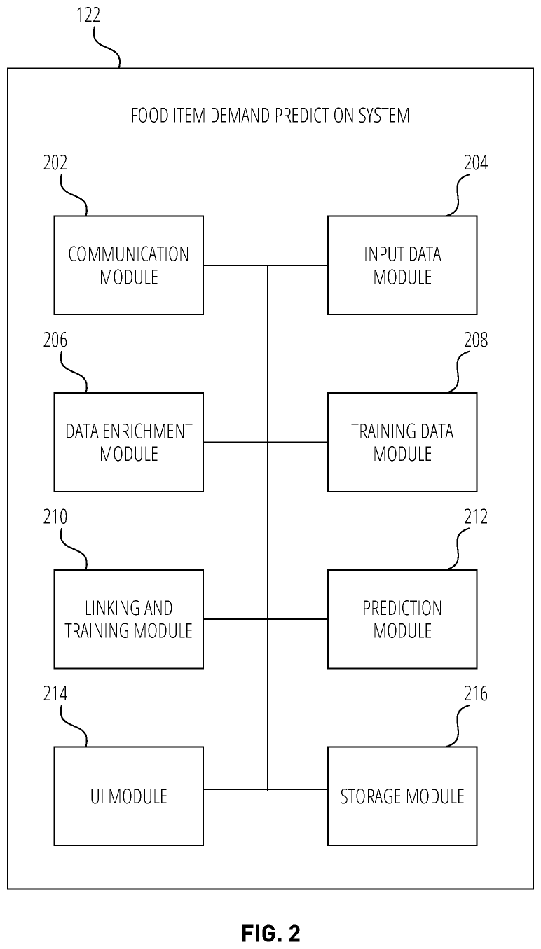

The application server 116 accesses application data (e.g., application data stored by the database servers 124) to provide one or more applications to the user device 106 via a web interface 132 or an app interface 134. For example, and as described further below according to examples and with specific reference to FIGS. 2 and 4-8, the application server 116, using the food item demand prediction system 122, may provide a demand prediction application suitable for predicting one or more target variables that relate to food items.

To access the demand prediction application provided by the food item demand prediction system 122, the user 128 may create an account with an entity associated with the server system 104, e.g., a service provider (or access an existing account with the entity). The user 128 may use account credentials to access the web interface 132 (via a suitable web browser) and request access to the demand prediction application. The food item demand prediction system 122 may automatically create a service instance associated with the demand prediction application at the application server 116 which can be accessed by the user device 106 via one or more service APIs to utilize functionality described herein. The user 128 may also, in some examples, access the demand prediction application using a dedicated programmatic client 108, in which case some functionality may be provided client-side and other functionality may be provided server-side.

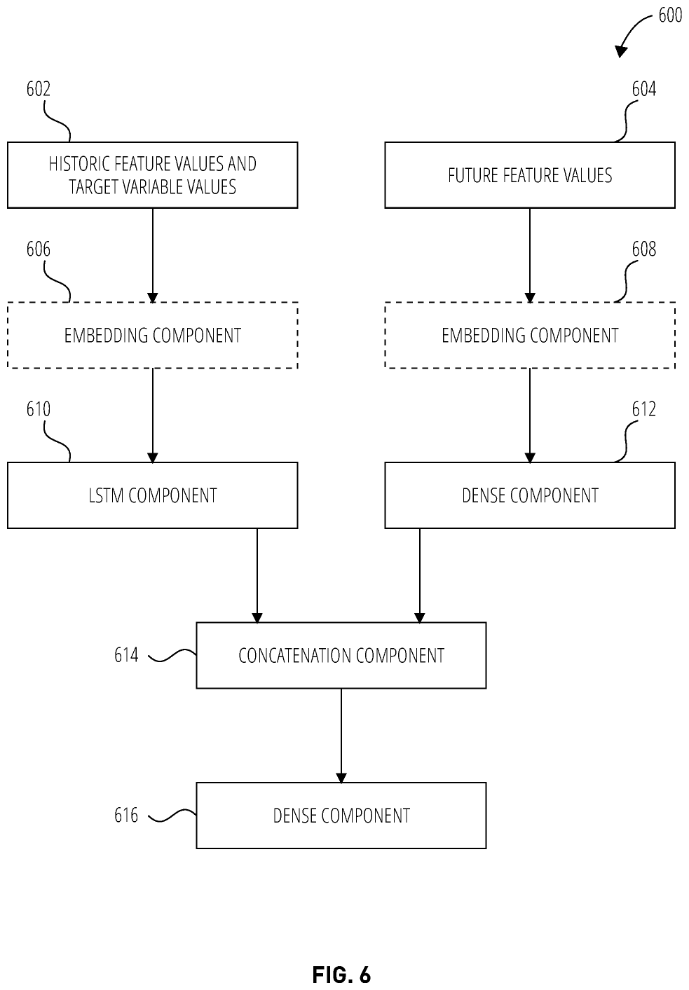

In some examples, the application server 116 is part of a cloud-based platform provided by the entity associated with the server system 104 that allows an account holder (e.g., the food establishment 130) to build, train, deploy, run, or manage (e.g., retrain, link, or adjust) machine learning models with an architecture as described herein, e.g., with reference to FIG. 6. The food item demand prediction system 122 may provide a user-friendly interface facilitating communication between the user 128 and the food item demand prediction system 122.

The food item demand prediction system 122 may enable the user 128 to perform or initiate various actions, via the user device 106, such as data preparation, model building, training and retraining, and deployment. This may include enabling the user 128 to upload data, facilitating the processing of data (e.g., data cleansing, augmentation, or transformation), enabling the user 128 to update machine learning models on a regular basis, or providing visualization and exploration tools that assist the user 128 in identifying patterns or correlations in their data, or in the outputs of the machine learning models.

The food item demand prediction system 122 may also provide the user 128 with options to customize and fine-tune models and to evaluate or compare the performance of different models, e.g., using built-in metrics. The food item demand prediction system 122 may provide various deployment functionality, enabling the user 128 to deploy a built or selected model to a production environment, e.g., an enterprise system of the food establishment 130. To this end, the food item demand prediction system 122 may provide several deployment options, including, for example, batch processing, as well as integration with other systems, e.g., other enterprise systems used by the user 128 or the food establishment 130.

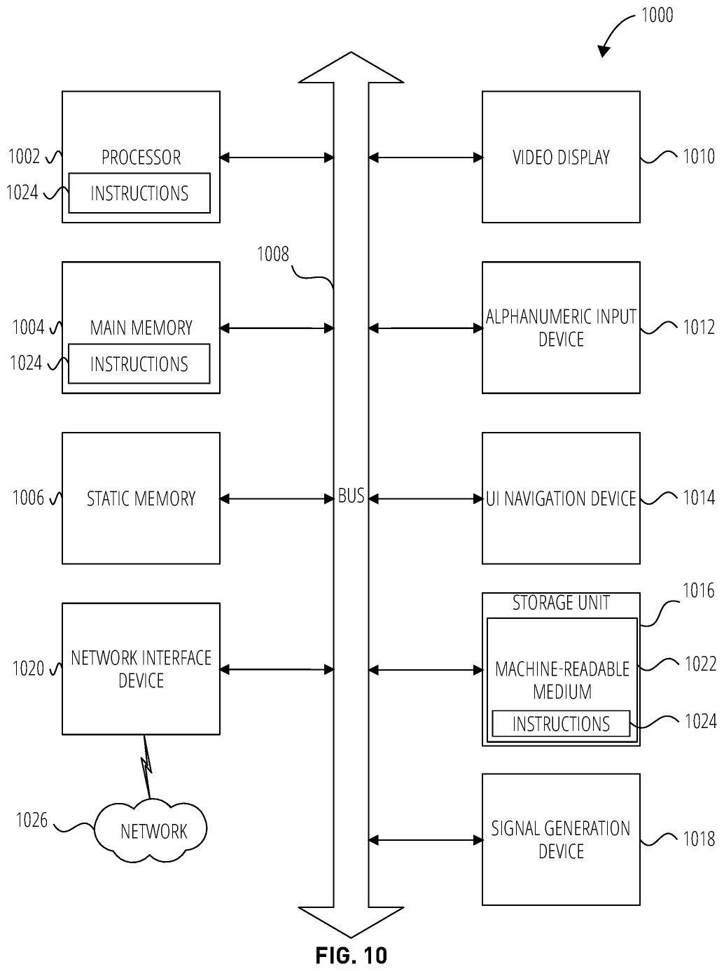

One or more of the application server 116, the database servers 124, the API server 118, the web server 120, and the food item demand prediction system 122 may each be implemented in a computer system, in whole or in part, as described below with respect to FIG. 10. In some examples, third-party applications, such as a third-party application 114 executing on a third-party server 112, can communicate with the application server 116 via the programmatic interface provided by the API server 118. For example, a third-party application may support one or more features or functions on a website or platform hosted by a third party, or may perform certain methodologies and provide input or output information to the application server 116 for further processing or publication. For example, the third-party application 114 may provide a sales reporting tool, allowing the user 128 to feed sales data from the third-party application 114 directly to the food item demand prediction system 122 for use in generating certain demand forecasts. As another example, the third-party application 114 may provide an order management system, allowing the food item demand prediction system 122 to access order details of the food establishment 130 and update records stored in the database 126.

The network 102 may be any network that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

FIG. 2 is a block diagram of a food item demand prediction system 122, suitable for generating forecasts, according to some examples. The food item demand prediction system 122 is shown as including a communication module 202, an input data module 204, a data enrichment module 206, a training data module 208, a linking and training module 210, a prediction module 212, a user interface (UI) module 214, and a storage module 216. At least some of the modules shown in FIG. 2 are configured to communicate with each other (e.g., via a bus, shared memory, or a switch) to implement aspects of the demand prediction application. Any one or more of the modules described herein may be implemented using hardware (e.g., a processor of a machine). For example, any module described herein may be implemented by a processor configured to perform the operations described herein for that module. Moreover, any two or more of these modules may be combined into a single module, or the functions described herein for a single module may be subdivided among multiple modules. Furthermore, according to various examples, modules described herein as being implemented within a single machine, database, or device may be distributed across multiple machines, databases, or devices.

The communication module 202 receives data sent to the food item demand prediction system 122 and transmits data from the food item demand prediction system 122. For example, the communication module 202 may receive, from the third-party server 112, sales data containing details of sales made by the food establishment 130. Further, the communication module 202 may receive user input, such as training data batches, or instructions to train a model or deploy a model, originating from the user device 106. In some examples, the food item demand prediction system 122 is configured to receive requests and other data via API calls and return responses and results via the communication module 202, e.g., comprising data objects in the JavaScript Object Notation (JSON) data interchange format. Examples of such calls and responses are provided below.

The input data module 204 is responsible for managing various input data received from the food establishment 130 and suitable for use in generating demand predictions. Input data received from the food establishment 130 may include data relating to one or more food items. For example, a target variable (variable to be predicted by the food item demand prediction system 122) may be the number of food items of a particular type or category sold, e.g., the target variable may be the number of cheeseburgers sold on a specific day by a restaurant. In some examples described herein, the food item demand prediction system 122 is utilized to generate predictions for only one food item, and thus only one target variable. However, it will be appreciated that the food item demand prediction system 122 may predict multiple target variables using similar techniques.

In addition to target variable values, e.g., sales data for cheeseburgers sold each day, the input data received from the food establishment 130 may include values for a plurality of features analyzed by a machine learning model. These features may be referred to as “establishment input features.” Establishment input features may include establishment-specific features, as well as other features that relate to and are provided by the food establishment 130, but are not necessarily specific to the food establishment 130. Data relating to establishment input features may be stored in the database 126 by the storage module 216, e.g., in a structured format such as JSON or CSV (comma-separated values). Examples of establishment-specific features include, but are not limited to:
Establishment type, e.g., a fixed category value such as “fine dining,” “casual dining,” “fast food,” “pizza,” or “cafe.”
Food item category or cuisine type, e.g., a fixed category value such as “South Indian,” “North Indian,” “Chinese,” “Thai,” or “Italian.”
Establishment mealtime type, e.g., a fixed category value such as “breakfast,” “lunch,” or “full-time.”
Vegetarian or non-vegetarian, e.g., a Boolean value.
Delivery type, e.g., a Boolean value indicating whether online-based delivery is available.
Parking availability, e.g., a float value with zero indicating “no parking.”
Establishment geographic area, e.g., an area code of the food establishment 130 (such as a ZIP code or area PIN code).
Establishment geographic area income level, e.g., a float value providing an indication of average per-capita income in the establishment geographic area.
Establishment rating, e.g., a float value indicating a restaurant rating from a predefined ratings source.
Peak time, e.g., a category value (such as “Morning,” “Noon,” or “Evening”).
Food item price, e.g., a price in US Dollars for a cheeseburger, where the target variable is number of cheeseburgers sold.
Food item category, e.g., a category value (such as “starter,” “soup,” “main course,” or “dessert”).
Promotion/discount indicator, e.g., “yes” or “no.”

Examples of other features that relate to and are provided by the food establishment 130 include, but are not limited to:
Date, e.g., in the format DD/MM/YYYY.
Holiday indicator, e.g., a Boolean value indicating whether the date of a particular data point is a government holiday, federal holiday, regional holiday, or the like.
Festival category, e.g., a category variable indicating a type of festival or event taking place on a particular date.
Weather data, e.g., a category variable indicative of a weather forecast (such as “sunny,” “raining,” or “windy”).
Temperature data, e.g., a temperature forecast (such as an hourly forecast across a specific day in a list format).
Humidity data, e.g., a humidity forecast (such as an hourly forecast across a specific day in a list format).

As mentioned above, an order management system of the food establishment 130 may be communicatively coupled to the food item demand prediction system 122, allowing the food item demand prediction system 122 to obtain at least some of the establishment input feature values. The features provided by the food establishment 130, e.g., the values for the features described above, may be automatically enriched by the food item demand prediction system 122, in some examples, using the data enrichment module 206. Input features may be enriched by adding values of additional features not provided by the food establishment 130. These features may be referred to as establishment-external features or complementary features.

Examples of complementary features include, but are not limited to:
Establishment rating, e.g. a float value indicating a restaurant rating from a predefined online ratings source.
Competitor data, e.g., an integer value of the number of competitors of the food establishment 130 in a specified geographic area, a float value of the average ratings of these competitors, or an indicator of whether a competitor has a special offer or discount running on a particular day.
Social media data or online trend data, e.g., trend data pulled via an API from a social media platform (such as, in the case of Twitter™, a float value indicating the fraction of food-related tweets in the locality featuring the food establishment 130 within the past week).
Location data, e.g., the total number of searches for the food establishment 130 on a specified location platform (e.g., Google Maps™).
Other web search or web-based data, e.g., a float value indicating the fraction of web searches in the locality featuring the food establishment 130 within the past week, or a conversion value indicating the probability of an individual who searches for the food establishment 130 actually visiting the food establishment 130.

It is noted that the features that are restaurant-provided and the features that are added by the food item demand prediction system 122 as complementary features may vary, depending on the implementation. For example, in some cases, the establishment rating may be provided by the food establishment 130 as input data, while in other cases the establishment rating may be automatically obtained online as complementary data by the food item demand prediction system 122. As another example, in some cases, weather data may be provided by the food establishment 130 as input data, while in other cases the weather data may be automatically obtained online as complementary data by the food item demand prediction system 122, based on the location of the food establishment 130.

The data enrichment module 206 may comprise or implement one or more online data aggregator components to perform an auto-enrichment function. An online data aggregator is a program or script that extracts data from one or more sources on the Internet in real-time, using APIs or other suitable techniques. An online data aggregator may implement certain “scraping” or “crawling” functionalities. To obtain data for the complementary features, a data aggregator may access various sources, e.g., APIs providing access to Yelp™ (for restaurant reviews), Google Maps™ (for location data), or Twitter™ (for online trend data). Once the data aggregator has accessed the relevant data sources, the data may be parsed to extract relevant information, including values of the complementary features that relate to the food establishment 130. Data may be stored in the database 126 by the storage module 216, e.g., in a structured format such as JSON or CSV. A data aggregator may continuously or periodically rerun the relevant program or script to ensure that the most up-to-date data is obtained by the food item demand prediction system 122.

As mentioned above, the food item demand prediction system 122 may be used to generate forecasts for a single target variable or for multiple target variables (also known as labels). For example, the food establishment 130 may wish to obtain a forecast on a daily basis for each different food item that it offers on its menu. It will be appreciated that, in some examples, the number of labels provided during training should match the number of labels for which predictions are ultimately generated, as further described below.

Still referring to FIG. 2, the training data module 208 is responsible for defining and managing various training data sets. For example, each training data set may contain historic data for an observed period, such as a month. Training data is stored in the database 126 by the storage module 216. The linking and training module 210 is configured to enable training data sets to be linked to each other in a defined sequence, facilitating sequential data-based inferences. The linking and training module 210 is also configured to carry out training of one or more demand prediction machine learning models based on a defined sequence, and to carry out retraining of a machine learning model based on a modified sequence (e.g., a new sequence containing updated training data).

The prediction module 212 implements one or more demand prediction machine learning models to generate food item-related demand forecasts. In examples described herein, a deep learning model is used to predict the number of food items per category, type, or product. However, in some examples, other food-related items may be predicted, e.g., the number of incoming customers on a given day (or in some defined time window), the number of occupied tables, the number of raw materials or ingredients required, the number of birthday parties, or the number of staff members required to cover a particular shift.

The UI module 214 provides various UIs to enable the user 128 to interact with the food item demand prediction system 122 via the user device 106. For example, the UI module 214 may provide an uploading graphical UI of the demand prediction application that enables the user 128 to upload training data, historic sales data, feature data, or the like. The UI module 214 may also provide an instruction graphical UI of the demand prediction application that enables the user to initiate automated features, such as model training or inference. The UI module 214 may further provide a results interface of the demand prediction application that enables the user to view and interact with predictions generated by the prediction module 212.

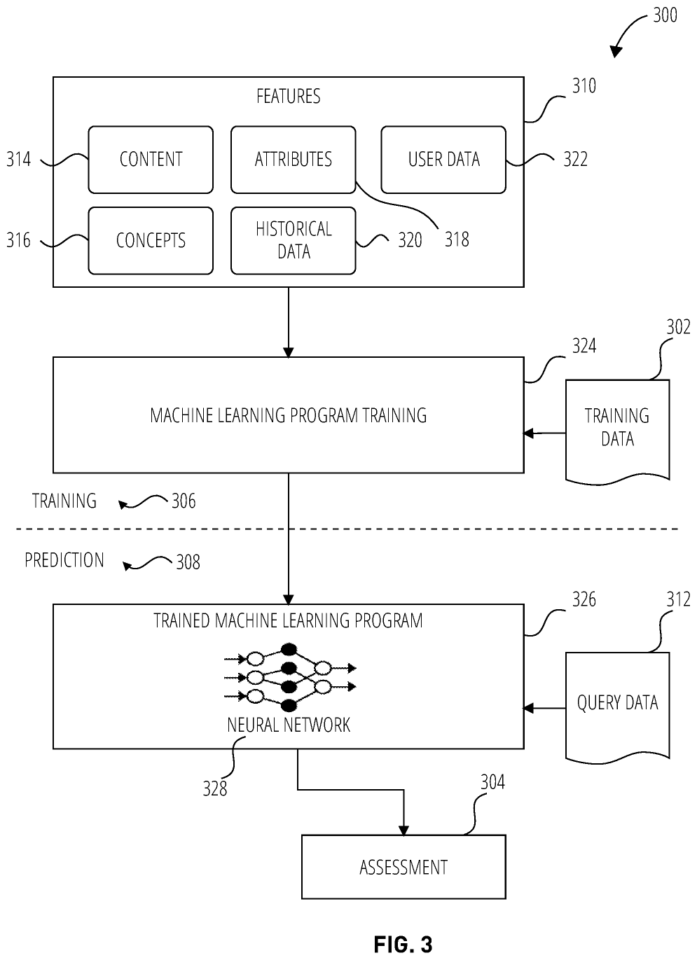

FIG. 3 generally illustrates certain aspects of training and use of a machine learning program, according to some examples. Specifically, FIG. 3 is a block diagram showing a machine learning tool 300, according to some examples. Machine learning tools such as the machine learning tool 300, also referred to as machine learning algorithms or programs, may be used as part of the systems and methodologies described herein to perform operations associated with food item demand forecasting.

Machine learning tools operate by building a model from example training data 302, also referred to as training data sets or simply training sets, in order to make data-driven predictions or decisions expressed as outputs or assessments (e.g., assessment 304). Although examples are presented with respect to a few machine learning tools, the principles presented herein may be applied to other machine learning tools.

One of ordinary skill in the art will be familiar with several machine learning tools that may be applied with the present disclosure, including logistic regression, linear regression, Naive-Bayes, random forests, decision tree learning, neural networks, deep neural networks, genetic or evolutionary algorithms, matrix factorization, support vector machines (SVM), and the like.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine learning tool 300 supports two types of phases, namely a training phase 306 and prediction phase 308. In training phases 306, supervised, unsupervised. or reinforcement learning may be used. For example, the machine learning tool 300 (1) receives features 310 (e.g., as structured or labeled/annotated data in supervised learning) or (2) identifies features 310 (e.g., unstructured or unlabeled data for unsupervised learning) in training data 302. In prediction phases 308, the machine learning tool 300 uses the features 310 for analyzing query data 312 to generate outcomes or predictions, as examples of an assessment 304.

In the training phase 306, feature engineering may be used to identify features 310 and may include identifying informative, discriminating, and independent features for the effective operation of the machine learning tool 300 in pattern recognition, classification, and regression. In some examples, the training data 302 includes labeled data, which is known data for pre-identified features 310 and one or more outcomes. In the context of a machine learning tool, each of the features 310 may be a variable or attribute, such as individual measurable property of a process, article, system, or phenomenon represented by a data set (e.g., the training data 302). Features 310 may also be of different types, such as numeric features, strings, and graphs, and may include one or more of content 314, concepts 316, attributes 318, historical data 320, or user data 322, merely for example. More specific examples of features, in the context of food item demand prediction, have been described above, with reference to FIG. 2.

In training phases 306, the machine learning tool 300 may use the training data 302 to find correlations among the features 310 that affect a predicted outcome or assessment 304, e.g., prediction of a target variable, such as the number of food items expected to be sold of a particular food item type. With the training data 302 and the identified features 310, the machine learning tool 300 is trained during the training phase 306 at machine learning program training 324. The machine learning tool 300 appraises values of the features 310 as they correlate to the training data 302. The result of the training is the trained machine learning program 326 (e.g., a trained or learned model).

The training phases 306 may involve machine learning, in which the training data 302 is structured (e.g., labeled during preprocessing operations), and the trained machine learning program 326 may implement a neural network capable of performing, for example, classification and clustering operations. In other examples, the training phase 306 may involve deep learning, in which the training data 302 is unstructured, and the trained machine learning program 326 implements a deep neural network that is able to perform both feature extraction and classification/clustering operations.

A neural network 328 generated during the training phase 306, and implemented within the trained machine learning program 326, may include a hierarchical (e.g., layered) organization of neurons. For example, neurons (or nodes) may be arranged hierarchically into a number of layers, including an input layer, an output layer, and multiple hidden layers. Each of the layers within the neural network can have one or many neurons and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron. In some examples, the neural network may also be one of a number of different types of neural networks, including a single-layer feed-forward network, an Artificial Neural Network (ANN), a RNN, a transformer network, a symmetrically connected neural network, and unsupervised pre-trained network, or a Convolutional Neural Network (CNN), merely for example.

A machine learning model may be run against training data for several epochs, in which the training data is repeatedly fed into the model to refine its results. In each epoch, the entire training data set is used to train the model. Multiple epochs (e.g., iterations over the entire training data set) may be used to train the model. In some examples, the number of epochs is 10, 100, 500, or 1000. Within an epoch, one or more batches of the training data set are used to train the model. Thus, the batch size ranges between 1 and the size of the training data set while the number of epochs is any positive integer value. The model parameters are updated after each batch (e.g., using gradient descent).

Each model may develop a rule or algorithm over several epochs by varying the values of one or more variables affecting the inputs to more closely map to a desired result, but as the training data set may be varied, and is preferably very large, perfect accuracy and precision may not be achievable. A number of epochs that make up a training phase 306, therefore, may be set as a given number of trials or a fixed time/computing budget, or may be terminated before that number/budget is reached when the accuracy of a given model is high enough or low enough or an accuracy plateau has been reached. For example, if the training phase 306 is designed to run n epochs and produce a model with at least 95% accuracy, and such a model is produced before the nth epoch, the training phase 306 may end early and use the produced model satisfying the end-goal accuracy threshold. Similarly, if a given model is inaccurate enough to satisfy a random chance threshold, the training phase 306 for that model may be terminated early, although other models in the training phase 306 may continue training. Similarly, when a given model continues to provide similar accuracy or vacillate in its results across multiple epochs—having reached a performance plateau—the training phase 306 for the given model may terminate before the epoch number/computing budget is reached.

Once the training phase 306 is complete, a model is finalized. In some examples, models that are finalized are evaluated against testing criteria. In a first example, a testing data set that includes known outputs for its inputs is fed into the finalized model to determine an accuracy of the model in handling data that it has not been trained on. In a second example, a false positive rate or false negative rate may be used to evaluate the models after finalization. In a third example, a delineation between data clusterings may be used. For instance, clusterings generated by a model can be compared with a ground truth clustering (if available), or with the clustering generated by another model that is known to perform well on the same task.

During prediction phases 308, the trained machine learning program 326 is used to perform an assessment 304. Query data 312 is provided as an input to the trained machine learning program 326, and the trained machine learning program 326 generates the assessment 304 as output, responsive to receipt of the query data 312.

In some examples, a machine learning model may be trained to process multiple inputs, or sets of inputs, during a prediction phase 308. Such models may be referred to as “multi-input” models. Each input, or set of inputs, may represent different aspects or features of data. A multi-input machine learning model may comprise multiple layers. Some layers may process respective inputs separately, and outputs from such layers may be combined, e.g., combined and passed through one or more further layers to produce a final assessment 304.

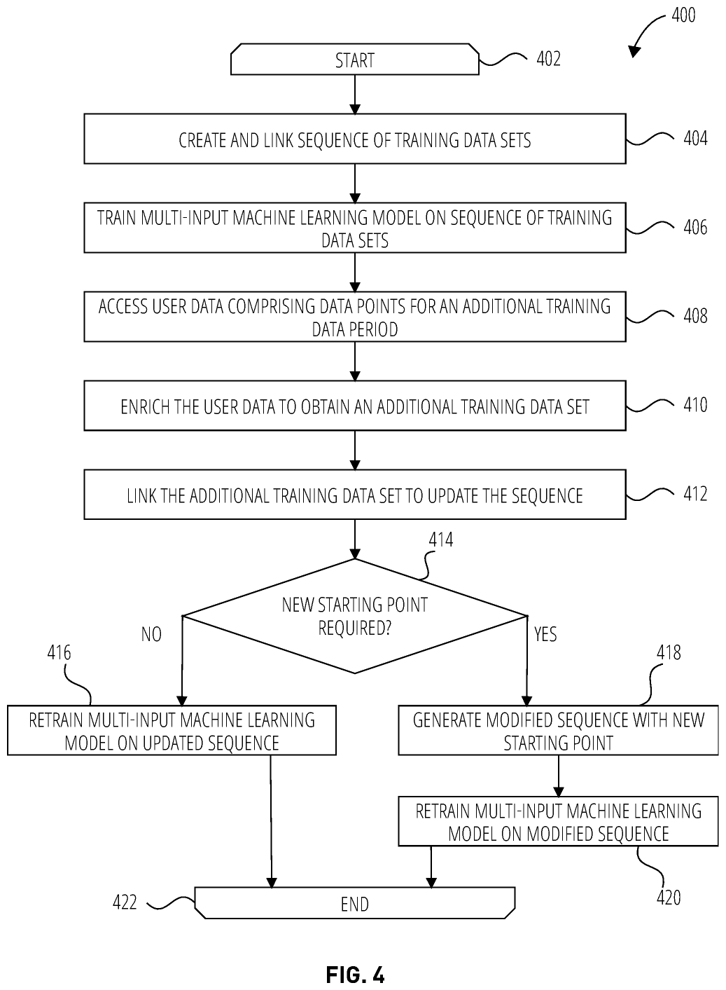

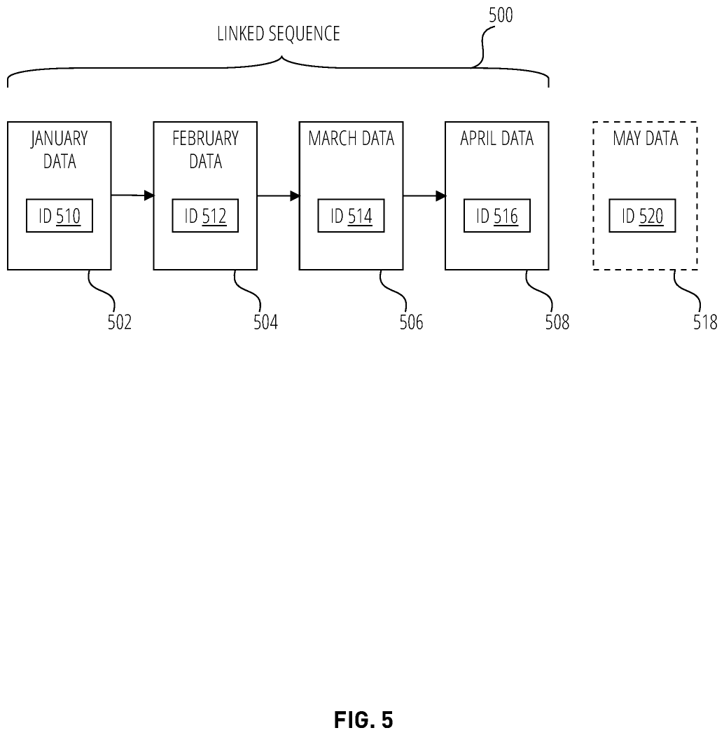

FIG. 4 is a flowchart illustrating operations of a method 400 suitable for training a machine learning model to generate food item demand predictions, according to some examples. By way of example and not limitation, aspects of the method 400 may be performed by the modules, components or databases shown in FIG. 1 and FIG. 2. Further, and also by way of example and not limitation, a sequence of training data sets shown in FIG. 5 is referenced below to facilitate understanding of certain aspects of the disclosure.

In FIG. 4, the machine learning model is a multi-input machine learning model that is trained on a linked sequence of training data sets. Each training data set in the sequence of training data sets comprises training data covering a respective training data period. In FIG. 4, and merely as an example, each training data period is a month, and each training data set comprises sales data of a food item sold by the food establishment 130 and corresponding feature values for each day of the relevant month. In other examples, a training data period may span a different period (e.g., a week, or a year).

The method 400 commences at opening loop element 402, and proceeds to operation 404, where the food item demand prediction system 122 creates and links a sequence of training data sets. As mentioned above, the food establishment 130 provides input data, e.g., via an API used by the user device 106 to access the demand prediction application, to the food item demand prediction system 122. In the example of FIG. 4, the input data provided by the food establishment 130 includes, for each month, a sequence of data points corresponding to the days of the month. The sequence of data points defines a time series, and a machine learning model may thus be trained to perform a time series-based analysis to generate demand forecasts, as described further below. Each data point (in this case, data for a day) comprises a value of a target variable. As the target variable is the number of food items of the particular type, the value of the target variable in each data point is a positive integer value.

For example, and as shown in the diagram of FIG. 5, data points for four previous months in a given year may be provided to form a linked sequence 500 (e.g., January data 502, February data 504, March data 506, and April data 508). The food item demand prediction system 122 may create and link the sequence and store a record thereof in the database 126. The input data further includes, in each data point, a value of each of a plurality of establishment input features (e.g., values for the date, parking availability, holiday data, and delivery type as provided by the food establishment 130). The food item demand prediction system 122 automatically enriches the input data provided by the food establishment 130 to add values of a plurality of complementary features (e.g., an online trend value, a competitor rating average value, and a search conversion value automatically obtained by a data aggregator component of the food item demand prediction system 122).

In some examples, and as is the case in FIG. 4, a training data set thus comprises a sequence of observed values of the target variable and corresponding input feature values for each data point in the sequence. The input feature values in each data point include establishment input feature values provided by the food establishment 130, as well as complementary feature values automatically added to the training data set. It will be appreciated that some of these values may be dynamic and change from day to day within a time series (e.g., holiday data), while other values may be static or constant (e.g., cuisine type associated with a particular food item).

The linked sequence 500 of training data sets may be stored in the database 126. Training data sets may be linked either before or after automatic data enrichment is performed. In some examples, the food item demand prediction system 122 generates and stores a unique training data identifier (ID) for each training data set, referred to as a data set ID (see, in FIG. 5, the ID 510, ID 512, ID 514, and ID 516).

At operation 406, the machine learning model is trained on a sequence of training data sets, e.g., the linked sequence 500 as shown in FIG. 5, by the linking and training module 210 of the food item demand prediction system 122. In some examples, the food item demand prediction system 122 generates a sequence ID that identifies the entire linked sequence 500. Once the linked sequence 500 has been used to train a model, the relevant sequence ID may be stored by the food item demand prediction system 122 in association with a model name or other model identifier.

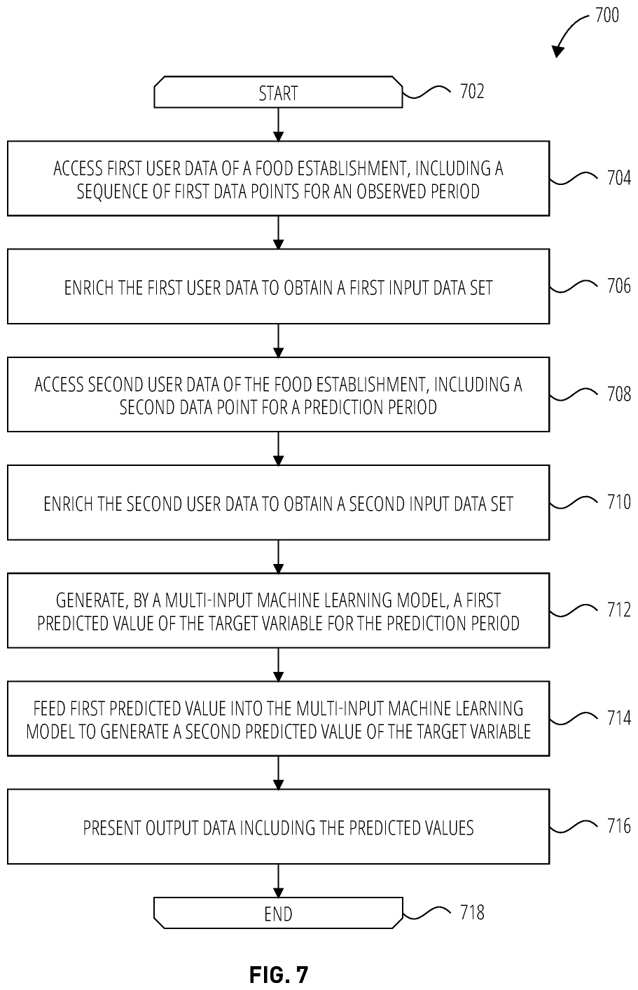

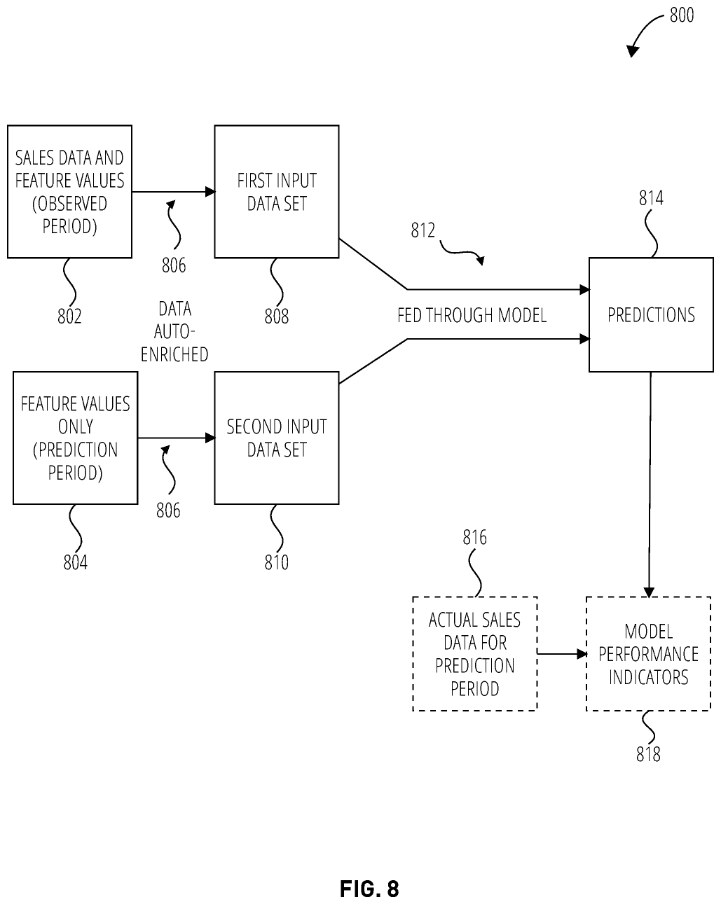

The machine learning model is trained to generate a predicted value of the target variable for a prediction period, e.g., a next day. In some examples, the machine learning model comprises a RNN to allow for time series forecasting. A RNN can be trained to process input data one time step at a time, using feedback loops to maintain or adjust an internal state, and training the RNN to minimize the difference between its predicted and actual outputs. The RNN can capture patterns and dependencies based on an input sequence, making it useful for forecasting future values of the target variable. Once trained, the machine learning model may be used for inference as required, e.g., based on the needs of the food establishment 130. Further detail regarding the architecture of such a machine learning model is provided with reference to FIG. 6 below, while further detail regarding inference is provided with reference to FIG. 7 and FIG. 8 below.

Still referring to FIG. 4, the method 400 includes accessing user data comprising data points for an additional training data period. at operation 408. For example, after the machine learning model has been trained on the sales data and feature data for January to April (e.g., the linked sequence 500 as per the non-limiting example in FIG. 5), and used to run inference for predictions in May, the user 128 may wish to add the observed (actual) sales data for May to the food item demand prediction system 122 to obtain an updated machine learning model.

The food establishment 130 may thus provide a sequence of data points for an additional training data period, with each data point including an observed value of the target variable (e.g., number of food items sold), and a value of each of the establishment input features that were included in the previous training data sets (e.g., January to April). At operation 410, the data provided by the food establishment 130 is automatically enriched by the food item demand prediction system 122 to obtain an additional training data set (e.g., a training data set for the month of May is obtained by adding a value of each of the complementary features that were included in the previous training data sets).

The food item demand prediction system 122 may generate a data set ID for the additional training data set (e.g., ID 520 as shown in FIG. 5 for the May data 518). Alternatively, the user 128 may provide a data set ID for the May data 518. To link the additional training data set to the original sequence, the user 128 may make a selection indicating that the data set ID of the additional training data set is to be appended to the data set ID for April (e.g., ID 516), or that the data set ID of the additional training data set is to be appended to the original sequence ID. In response, the food item demand prediction system 122 may generate and store an appropriate link in the database 126.

At operation 412, the additional training data set (e.g., the May data 518 as shown in FIG. 5) is linked to the original sequence to obtain an updated sequence, e.g., a sequence of training data extending from January to May of the given year. The food item demand prediction system 122 may generate a sequence ID for the updated sequence. At that stage, a new machine learning model may be trained to ensure that the new data is taken into account, e.g., by reperforming operations similar to operation 404 and operation 406. However, in some examples, it may be preferably to retrain the existing model, as opposed to training a new model “from scratch.”

In some examples, the sequence may be modified to obtain a modified sequence of training data that commences from a new starting point, allowing for more efficient retraining or improved trend capturing. More specifically, given that the training data sets are linked to each other in chronological order, and that each data set is identifiable by its unique data set ID, the user 128 may specify a new starting point for a modified sequence. At decision operation 414, the user 128 may make a selection, via a suitable UI of the demand prediction application, indicating that the modified sequence should commence with the February training data set (e.g., the February data 504) and end with the new training data set for May. The user 128 may, for example, provide the data set ID (ID 512) to indicate this modification instruction.

Accordingly, in some examples, the food item demand prediction system 122 may receive a user selection of a training data identifier (e.g., a data set ID or a sequence ID), and generate a modified sequence that commences at a training data set that corresponds to the user selection. The food item demand prediction system 122 then generates the modified sequence (operation 418) and retrains the machine learning model on the modified sequence (operation 420) to obtain an updated machine learning model for use in future predictions (e.g., from June onwards). A model name, or other model identifier, may be stored in association with an ID of the modified sequence. If, at decision operation 414, the user 128 indicates that the updated sequence (including May) can be maintained (e.g., January to May), the machine learning model may be retrained based on the update sequence at operation 416.

To retrain a model, the food item demand prediction system 122 may feed the additional training data set, or the updated/modified sequence, to the model and adjust its parameters. It will be appreciated that, prior to training or retraining, the food item demand prediction system 122 may preprocess and transform training data as required. This may include, for example, data cleaning, scaling, or feature engineering. It will further be appreciated that, once a model has been trained or retrained, the food item demand prediction system 122 may be used to evaluate its performance. The method 400 ends at closing loop element 422.

Referring again to FIG. 5, examples of the present disclosure provide a highly customizable tool that allows a user 128 to define or use linked sequences of training data sets, e.g., the linked sequence 500. The user 128 may, for example, upload the January data 502 at the end of January, and then upload the February data 504 at the end of the February, with the two sets being linked to each other by the food item demand prediction system 122. This process may continue to ensure that the linked sequence 500 is updated periodically, and machine learning models may be updated or retrained as required by using the linked sequence 500.

In this way, the user 128 may train a model from the relevant sequence, or from a modified sequence, starting at any period (e.g., any month) in the sequence, e.g., to keep track of a specific historic trend, while also capturing a new trend.

In some examples, the machine learning model is trained to generate a predicted value of the target variable based on a first input data set and a second input data set that are processed differently by the machine learning model. FIG. 6 shows a model architecture 600 of a multi-input machine learning model in the form of a parallel input machine learning model, according to some examples, that illustrates these differences in processing.

In the model architecture 600 of FIG. 6, the first input data set includes historic feature values and target variable values 602. For example, the model may be trained on a sequence of training data covering January to April of a given year, and the user 128 of the demand prediction application may wish to generate a predicted value of the target variable for May 16 of the same year. The first input data set may, in such a case, include the actual (observed values) of the target variable (e.g., number of food items sold) for May 1 to May 15 of the same year, together with values for the relevant input features. As mentioned, the input features may include establishment input features and complementary features. Further, in the model architecture 600 of FIG. 6, the second input data includes future feature values 604. For example, the second input data may include values for the same input features as the first input data set, but for a prediction period as opposed to an observed period, e.g., for May 16. As the prediction is generated with respect to a future value, the future feature values 604 do not include a target variable.

The first input data set is processed through an RNN branch of the model architecture 600, while the second input data set is processed through a conventional feedforward branch of the model architecture 600. In some examples, the first input data set has multiple data points (one data point per day) of non-sales features (e.g., day, weather, restaurant rating, etc.), as well as sales data. The sequence can thus be processed by the RNN branch (e.g., a long short-term memory (LSTM) component, as described below). On the other hand, in some examples, the second input data set has only one data point without sales information, given that the sales information is to be forecasted. As there is no “sequence” to process, a conventional feedforward branch may thus effectively process the second input data set. An RNN can be trained to receive and separately process each time step corresponding to a single data point in the time series (e.g., each day, from May 1 to May 15). By including feature values as input alongside sales data for each day, the RNN is provided with additional contextual information to assist in capturing patterns and dependencies in the time series. For each data point (e.g., day), the target variable value and the relevant feature values may be concatenated.

As a non-limiting example, the model architecture 600 of FIG. 6 includes a LSTM component 610 that processes the historic feature values and target variable values 602, and a separate dense component 612 that processes the future feature values 604. The LSTM component 610 may include one or more LSTM layers. The dense component 612 may include one or more dense layers. The shape of initial inputs may be defined as follows:
Input at 602: Input (None, 15(Seq Len), Feature Len)
Input at 604: Input (None, Feature Len)

In the above examples, the input “None” is a dimension representing batch size, with “None” indicating that batch sizes can vary. The dimension “15” represents the number of time steps in the input sequence. Each time step has a corresponding vector of length “Feature Len.” It is noted that certain feature values, e.g., values of categorical features, may be passed through an embedding component (embedding component 606 or embedding component 608) prior to reaching the LSTM component 610 or dense component 612, as the case may be. Each embedding component 606 may include one or more embedding layers. A constructor call for an embedding component may, for example, be defined as:
Input at 606 or 608: Embedding (vocab_size, 256)

This creates an embedding layer that maps input tokens, represented as integers, to dense vectors of size 256. The “vocab_size” parameter specifies the size of the input vocabulary, which is the number of unique tokens in the input data. Each token is represented by a unique integer value, which is used as input to the embedding layer. The second parameter, 256, specifies the size of the output embedding vector for each input token. The embedding layer allows the neural network to learn a dense, continuous representation of the input tokens, which can improve the ability to generalize to new, unseen data.

The embedding component 606 or embedding component 608 is only applied to certain features, e.g., categorical or discrete features of the input data, while numerical features may bypass the embedding component and proceed directly to the LSTM component 610 or the dense component 612. Output of the relevant embedding component may be combined or aggregated with, e.g., concatenated with, the features not considered by the embedding component, which may be scaled or normalized and passed on to the next component or layer.

Referring specifically to the LSTM component 610, this component may take a sequence of input vectors as its input, with each vector representing a particular time step (e.g., May 1 to May 15). The output of the LSTM component 610 at each time step may comprise a hidden state vector that contains information about the input sequence up to that point in time. The hidden state vector may be passed on to the next time step as input, allowing the LSTM to remember information from previous time steps. The LSTM component 610 may also have a cell state vector (selective memory) that is updated at each time step.

Referring now to the dense component 612, this component may process the future feature values 604, e.g., using matrix multiplication. This may include multiplying the input data by a weight matrix, transforming the resulting matrix, and passing the resulting matrix through an activation function to produce output. The dense component 612 provides a non-linear transformation of the future feature values 604 that maps the input data to a higher-level representation, used downstream for prediction.

First output of the first component (LSTM component 610) and second output of the second component (dense component 612) may be aggregated or combined for downstream processing. As shown in FIG. 6, in some examples, first output of the first component and second output of the second component are concatenated at a concatenation component 614 to obtain a concatenated vector. The concatenation component 614 may include one or more concatenation layers. Subsequently, the concatenated vector is processed by a third component in the example form of another dense component 616 (e.g., another dense layer) to generate the predicted value of the target variable, e.g., the predicted number of food items sold on May 16.

The predicted value of the target variable, e.g., the value for May 16, may then be fed back into the model (e.g., as part of updated historic feature values and target variable values 602) and used for future predictions, e.g., for May 17. For this purpose, the predicted value is deemed to be an actual (observed) value. This process can be repeated to forecast food item demand for multiple future time steps.

While an RNN-based architecture has been described above, other types of machine learning architectures may also be employed. For example, a transformer-based architecture may be utilized in some examples. In contrast to RNNs, a transformer model receives the entire input sequence simultaneously, and uses self-attention mechanisms to generate correlations between all elements of the input sequence, regardless of their location in the sequence. In some examples, a transformer model may thus be used to perform techniques as described herein, e.g., to improve capturing of long-term dependencies.

FIG. 7 is a flowchart illustrating operations of a method 700 suitable for food item demand prediction, according to some examples. By way of example and not limitation, aspects of the method 400 may be performed by the modules, components or databases shown in FIG. 1 and FIG. 2.

The method 700 commences at opening loop element 702 and proceeds to operation 704, where the input data module 204 of the food item demand prediction system 122 accesses first user data of the food establishment 130. The first user data is a sequence of first data points for an observed period (e.g., a sequence of days). Each first data point may include a value of the target variable and values for one or more establishment input features. At operation 706, the data enrichment module 206 of the food item demand prediction system 122 automatically enriches the first user data with corresponding values of one or more complementary features, thereby generating a first input data set for the machine learning model.

The method 700 proceeds to operation 708, where the input data module 204 of the food item demand prediction system 122 accesses second user data of the food establishment, including a second data point for a prediction period (e.g., a future day). The prediction period may thus include only a single data point. For example, the second data point may include values of the one or more establishment input features corresponding to the future day for which the prediction is required. However, in other examples, the prediction period may include multiple data points. For example, the first input data may include sales data and features as observed in the month of April, while the second input data includes only the features required for the month of May. In such a case, the prediction period may include a plurality of second data points, each with feature values for “future features.” The prediction period, and number of second data points, may be user-selectable, thus providing the food establishment 130 with a flexible and customizable prediction tool.

At operation 710, the data enrichment module 206 automatically enriches the second user data with corresponding values of the one or more complementary features, thereby generating a second input data set for the machine learning model. At operation 712, the prediction module 212 executes the trained machine learning model to generate a first predicted value of the target variable for the prediction period. The machine learning model may be a multi-input machine learning model that processes the first input data set and the second input data set differently, e.g., as described with reference to FIG. 6.

In some examples, and as shown in FIG. 7, the first predicted value may be automatically fed into the machine learning model to generate a second predicted value of the target variable (operation 714), e.g., a prediction for a day following the day for which the first predicted value was generated. In other words, when predicting food item demand for a particular day, the tool provided in examples of the present disclosure takes a recent demand trend into account, e.g., the past 15 days or the past 30 days, depending on the configuration of the first input data. During inference, in order to forecast for a “first day,” the recent demand trend, in combination with factors such as the weights and parameters established during model training, the future feature values, and the enrichment of both past and future features automatically performed by the food item demand prediction system 122, may allow the multi-input machine learning model to generate accurate estimates. Once predicted demand has been generated for the “first day,” that prediction can be used as input for future days.

The method 700 includes presenting output data, including the predicted values, at the user device 106 of the user 128, at operation 716. As mentioned, the demand prediction application may provide a UI that presents predictions to the user 128 at the user device 106. The method ends at closing loop element 718.

FIG. 8 shows a diagram 800 illustrating the generation of a food item demand prediction, according to some examples. By way of example and not limitation, aspects referred to in FIG. 8 may be performed by the modules, components or databases shown in FIG. 1 and FIG. 2.

In this example, sales data and feature values for an observed period 802 and feature values for a prediction period 804 are automatically enriched, by an auto-enrichment function 806 performed by the food item demand prediction system 122, to obtain a first input data set and a second input data set, respectively. The prediction period may, for example, be the month of May in a given year, and the observed period may be the month of April in the same year. The sales data may include sales figures for a plurality of food items sold by the food establishment 130 for each day in April. A first input data set 808 thus covers the actual sales data and actual feature values, including both those provided by the food establishment 130 and those added using the auto-enrichment function 806. A second input data set 810 covers expected (or known) future feature values for the month of May for the same features as those included in the first input data set 808.

The use of two input data sets as described herein allows a machine learning model to analyze both the actual sales and feature values, or trends, and those expected (or known) in the future. In a prediction phase 812, the machine learning model processes the first input data set 808 and the second input data set 810 and generates a set of predictions 814, e.g., predicted demand (or sales) for each day in the month of May, broken down by label, e.g., for each of the plurality of food items of the food establishment 130.

It may be desirable to test or evaluate the performance of the model. For example, once the actual sales data for the prediction period 816 is known, the user 128 may upload the actual sales data to the food item demand prediction system 122. The food item demand prediction system 122 may automatically compare the forecasted values (predictions 814) with the actual sales data for the prediction period 816 and present comparison results to the user 128 via a suitable UI. One or more model performance indicators 818 may be employed for this purpose. Examples of the model performance indicators 818 include, but are not limited to: RMSE (Root Mean Squared Error), MAE (Mean Absolute Error), MAPE (Mean Absolute Percentage Error), and R2 (Coefficient of Determination).

RMSE measures the average difference between the predicted target values and the actual values, with the differences squared to give greater weight to larger errors. MAE is a metric that measures the average magnitude of errors between the predicted and actual values. It is calculated as the average absolute difference between the predicted and actual values across all predictions in a test set. MAPE measures the average percentage difference between the predicted and actual values, where the difference is divided by the actual values. Finally, R2 measures the proportion of the variance in the actual values that is explained by the predicted values.

As mentioned above, the food item demand prediction system 122 described herein may be configured to receive requests and other data via API calls and return responses and results via the communication module 202. Table 1 below summarizes a set of example API calls in JSON format, together with example payloads and responses, that may be used in some examples, e.g., to provide a demand prediction application as a service to the food establishment 130. It will, however, be appreciated that this protocol and format combination is merely an example, and that other protocols or formats may be employed in other examples.

TABLE 1
Examples of API calls, payloads and responses

| API call | Description | Example payload | Example response |
|---|---|---|---|
| POST | Data set creation: this | { | { |
| /datasets | call may be used to | “name”: | “dataset_id”: |
| | create and link data | “Data_April”, | “c1c2b23c-0ba8- |
| | sets. | “previous_dataset_id”: | 41a7-90c4- |
| | | “d1ab4cb6- | 1851dd0fd1fc” |
| | | 0b75-47b3-8b24- | } |
| | | 14b751e12bd1”, | |
| | | } | |
| POST | Date set upload: this | Binary CSV file | { |
| /datasets/ | call may be used to | | “dataset_id”: |
| {dataset_id}/ | upload training files. | | {dataset_id}, |
| {previous_dataset_id}/ | | | “validation_status”: |
| upload | | | { } |
| | | | } |
| POST | Job creation: this call | { | { |
| /job | may be used to trigger | “dataset_id”: | “job_id”: |
| | model training. Here, | {dataset_id}, | “41c1c69b-439c- |
| | “dataset_id” indicates | “previous_model_name”: | 4bce-8064- |
| | the data set ID from | “model_april”, | aa195a319c72”, |
| | which training needs | “model_name”: | “previous_model_name”: |
| | to be started, and | “model_may” | “model_april”, |
| | “previous_model_name” | } | “model_name”: |
| | is the name of the | | “model_may”, |
| | model which needs to | | “job_status”: { }, |
| | be retrained. This is | | “model_metrics”: |
| | optional. Further, | | {“RMSE”, “MAE”, |
| | “model_name” is the | | “MAPE”, R2} |
| | name of the new | | } |
| | model which will be | | |
| | created. | | |
| POST | Model deployment: | { | { |
| /deployment | This call may be used | “model_name”: | “deployment_id”: |
| | to deploy the new | “model_may” | “1891fbf2-983f- |
| | model for forecasting. | } | 40a4-bafe- |
| | The response includes | | fa2b6c14f743”, |
| | the inference Uniform | | “model_name”: |
| | Resource Locator | | “model_may”, |
| | (URL) to obtain future | | “deployment_status”: { }, |
| | forecasts of food item | | “inference_url”: { } |
| | demand. | | } |
| POST | Inference: This call | { | Forecast of demand, |
| {inference_url} | may be used by a user | “objects”: | e.g., predicted |
| | to pass historic (e.g., | [ | number of food |
| | previous days') | { | items sold per label |
| | features and target | “previous_features+ | |
| | variables (e.g., sales | sales”: [ ], | |
| | data) of food items, as | “Future features”: | |
| | well as features of the | [] | |
| | future days, to obtain | }, | |
| | the demand forecast as | {[....]}, | |
| | output. The system | ], | |
| | may auto-enrich the | “days_to_forecast”: | |
| | user's data. | 15 | |
| | | } | |
| POST | Get metrics: this call | { | { |
| /get_metrics/ | may be used to obtain | “objects”: | “RMSE”: |
| {model_name} | the metrics of the | [ | “MAE” : |
| | model, e.g., to | { | “MAPE”: |
| | determine whether | “previous_features+ | “R2”: |
| | retraining is required. | sales”: [ ], | } |
| | | “Future_features”: | |
| | | [ ], | |
| | | “ground_truth_sales”: | |
| | | [ ] | |
| | | }, | |
| | | {[....]}, | |
| | | ], | |
| | | “days_to_forecast”: | |
| | | 15 | |
| | | } | |

A demand forecasting tool, according to some examples, may address a technical challenge faced in the food industry, where a restaurant or other food business may operate a large number of outlets or facilities and require a forecasting tool to be built for each outlet or facility. Using the demand forecasting tool described herein, a user may use the same framework for a large number of outlets or facilities, and simply adjust the input data as required to obtain predictions for the respective outlets or facilities.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a memory that stores instructions; and one or more processors configured by the instructions to perform operations comprising: enriching first user data of a food establishment to obtain a first input data set, the first user data comprising a sequence of first data points for an observed period, each first data point comprising an observed value of a target variable and a value of each of a plurality of establishment input features, the target variable being related to a food item, and the first user data being enriched, for each first data point, using values of a plurality of complementary features corresponding to the first data point; enriching second user data of the food establishment to obtain a second input data set, the second user data comprising a second data point for a prediction period, the second data point comprising a value of each of the establishment input features, and the second user data being enriched using values of the plurality of complementary features corresponding to the second data point; generating, by a multi-input machine learning model, a predicted value of the target variable for the prediction period, the multi-input machine learning model comprising a first component that processes the first input data set and a second component that processes the second input data set; and causing presentation, at a user device associated with the food establishment, of output data including the predicted value of the target variable.

In Example 2, the subject matter of Example 1 includes, wherein the multi-input machine learning model comprises a parallel input machine learning model in which the first component and the second component separately process the first input data set and the second input data set, respectively, and in which outputs of the first component and the second component are combined to generate the predicted value of the target variable.

In Example 3, the subject matter of Example 2 includes, wherein first output of the first component and second output of the second component are concatenated to obtain a concatenated vector, and wherein the concatenated vector is processed by a third component to generate the predicted value of the target variable.

In Example 4, the subject matter of Examples 2-3 includes, wherein the first component comprises a Recurrent Neural Network (RNN) and the second component comprises a feedforward network.

In Example 5, the subject matter of Example 4 includes, wherein the RNN comprises one or more long short-term memory (LSTM) layers, and wherein the feedforward network comprises one or more dense layers.

In Example 6, the subject matter of Examples 1-5 includes, wherein the prediction period is a first prediction period and the predicted value of the target variable is a first predicted value, the operations further comprising: automatically providing the first predicted value as input to the multi-input machine learning model to generate a second predicted value for a second prediction period that follows the first prediction period.

In Example 7, the subject matter of Examples 1-6 includes, wherein the multi-input machine learning model is trained on a linked sequence of training data sets, each training data set in the sequence of training data sets comprising training data covering a respective training data period.

In Example 8, the subject matter of Example 7 includes, the operations further comprising: enriching third user data of the food establishment to obtain an additional training data set, the third user data comprising a sequence of third data points for an additional training data period, each third data point comprising an observed value of the target variable and a value of each of the establishment input features, and the third user data being enriched, for each third data point, using values of the complementary features corresponding to the third data point; linking the additional training data set to the sequence of training data sets to obtain an updated sequence of training data sets; and storing the updated sequence of training data sets.

In Example 9, the subject matter of Example 8 includes, the operations further comprising: retraining the multi-input machine learning model on the updated sequence of training data sets.

In Example 10, the subject matter of Examples 8-9 includes, wherein each training data set is identified by a training data identifier, the operations further comprising: receiving a user selection of a training data identifier; generating a modified sequence of training data sets that commences at the training data set corresponding to the user selection and ends at the additional training data set; and retraining the multi-input machine learning model on the modified sequence of training data sets.

In Example 11, the subject matter of Examples 1-10 includes, wherein enriching the first user data comprises invoking an auto-enrichment function of an online data aggregator component.

In Example 12, the subject matter of Examples 1-11 includes, wherein the target variable is a number of food items sold by the food establishment.

In Example 13, the subject matter of Examples 1-12 includes, wherein the establishment input features comprise one or more of: date; holiday data; weather data; temperature data; humidity data; establishment type; cuisine type; delivery type; parking availability; establishment geographic area; establishment geographic area income level; establishment rating; peak time; food item price; food item category; or promotion data.

In Example 14, the subject matter of Examples 1-13 includes, wherein the complementary features comprise one or more of: competitor data; online trend data; web search data; location data; or social media data.

Example 15 is a method comprising: enriching first user data of a food establishment to obtain a first input data set, the first user data comprising a sequence of first data points for an observed period, each first data point comprising an observed value of a target variable and a value of each of a plurality of establishment input features, the target variable being related to a food item, and the first user data being enriched, for each first data point, using values of a plurality of complementary features corresponding to the first data point; enriching second user data of the food establishment to obtain a second input data set, the second user data comprising a second data point for a prediction period, the second data point comprising a value of each of the establishment input features, and the second user data being enriched using values of the plurality of complementary features corresponding to the second data point; generating, by a multi-input machine learning model, a predicted value of the target variable for the prediction period, the multi-input machine learning model comprising a first component that processes the first input data set and a second component that processes the second input data set; and causing presentation, at a user device associated with the food establishment, of output data including the predicted value of the target variable.

In Example 16, the subject matter of Example 15 includes, wherein the multi-input machine learning model comprises a parallel input machine learning model in which the first component and the second component separately process the first input data set and the second input data set, respectively, and in which outputs of the first component and the second component are combined to generate the predicted value of the target variable.

In Example 17, the subject matter of Example 16 includes, enriching third user data of the food establishment to obtain an additional training data set, the third user data comprising a sequence of third data points for an additional training data period, each third data point comprising an observed value of the target variable and a value of each of the establishment input features, and the third user data being enriched, for each third data point, using values of the complementary features corresponding to the third data point; linking the additional training data set to the sequence of training data sets to obtain an updated sequence of training data sets; and storing the updated sequence of training data sets.

Example 18 is a non-transitory computer-readable medium that stores instructions that, when executed by one or more processors, cause the one or more processors to perform operations comprising: enriching first user data of a food establishment to obtain a first input data set, the first user data comprising a sequence of first data points for an observed period, each first data point comprising an observed value of a target variable and a value of each of a plurality of establishment input features, the target variable being related to a food item, and the first user data being enriched, for each first data point, using values of a plurality of complementary features corresponding to the first data point; enriching second user data of the food establishment to obtain a second input data set, the second user data comprising a second data point for a prediction period, the second data point comprising a value of each of the establishment input features, and the second user data being enriched using values of the plurality of complementary features corresponding to the second data point; generating, by a multi-input machine learning model, a predicted value of the target variable for the prediction period, the multi-input machine learning model comprising a first component that processes the first input data set and a second component that processes the second input data set; and causing presentation, at a user device associated with the food establishment, of output data including the predicted value of the target variable.

In Example 19, the subject matter of Example 18 includes, wherein the multi-input machine learning model comprises a parallel input machine learning model in which the first component and the second component separately process the first input data set and the second input data set, respectively, and in which outputs of the first component and the second component are combined to generate the predicted value of the target variable.

In Example 20, the subject matter of Example 19 includes, the operations further comprising: enriching third user data of the food establishment to obtain an additional training data set, the third user data comprising a sequence of third data points for an additional training data period, each third data point comprising an observed value of the target variable and a value of each of the establishment input features, and the third user data being enriched, for each third data point, using values of the complementary features corresponding to the third data point; linking the additional training data set to the sequence of training data sets to obtain an updated sequence of training data sets; and storing the updated sequence of training data sets.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

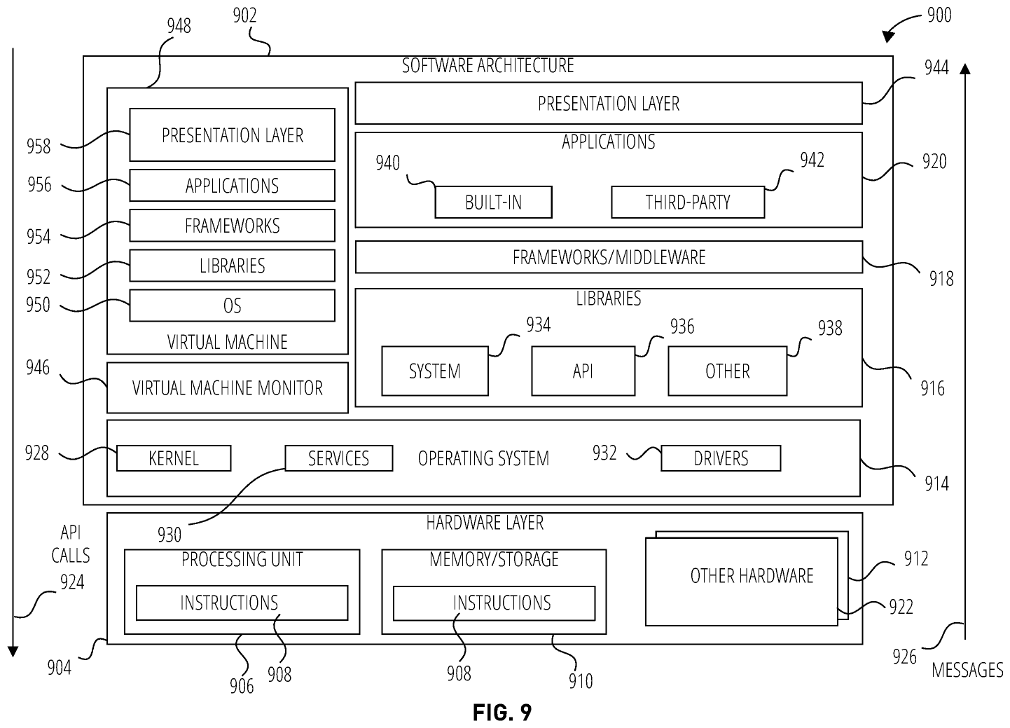

FIG. 9 is a block diagram 900 showing a software architecture 902 for a computing device, according to some examples. The software architecture 902 may be used in conjunction with various hardware architectures, for example, as described herein. FIG. 9 is merely a non-limiting illustration of a software architecture, and many other architectures may be implemented to facilitate the functionality described herein. A representative hardware layer 904 is illustrated and can represent, for example, any of the above referenced computing devices. In some examples, the hardware layer 904 may be implemented according to the architecture of the computer system of FIG. 10.

The representative hardware layer 904 comprises one or more processing units 906 having associated executable instructions 908. Executable instructions 908 represent the executable instructions of the software architecture 902, including implementation of the methods, modules, subsystems, and components, and so forth described herein and may also include memory and/or storage modules 910, which also have executable instructions 908. Hardware layer 904 may also comprise other hardware as indicated by other hardware 912 and other hardware 922 which represent any other hardware of the hardware layer 904, such as the other hardware illustrated as part of the software architecture 902.

In the architecture of FIG. 9, the software architecture 902 may be conceptualized as a stack of layers where each layer provides particular functionality. For example, the software architecture 902 may include layers such as an operating system 914, libraries 916, frameworks/middleware layer 918, applications 920, and presentation layer 944. Operationally, the applications 920 or other components within the layers may invoke API calls 924 through the software stack and access a response, returned values, and so forth illustrated as messages 926 in response to the API calls 924. The layers illustrated are representative in nature and not all software architectures have all layers. For example, some mobile or special purpose operating systems may not provide a frameworks/middleware layer 918, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of an interrupt and, in response, cause the software architecture 902 to pause its current processing and execute an interrupt service routine (ISR) when an interrupt is accessed.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 916 may provide a common infrastructure that may be utilized by the applications 920 or other components or layers. The libraries 916 typically provide functionality that allows other software modules to perform tasks in an easier fashion than to interface directly with the underlying operating system 914 functionality (e.g., kernel 928, services 930 or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks/middleware layer 918 may provide a higher-level common infrastructure that may be utilized by the applications 920 or other software components/modules. For example, the frameworks/middleware layer 918 may provide various graphic user interface (GUI) functions, high-level resource management, high-level location services, and so forth. The frameworks/middleware layer 918 may provide a broad spectrum of other APIs that may be utilized by the applications 920 or other software components/modules, some of which may be specific to a particular operating system or platform.

The applications 920 include built-in applications 940 or third-party applications 942. Examples of representative built-in applications 940 may include, but are not limited to, a contacts application, a browser application, a book reader application, a location application, a media application, a messaging application, or a game application. Third-party applications 942 may include any of the built-in applications as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 942 may invoke the API calls 924 provided by the mobile operating system such as operating system 914 to facilitate functionality described herein.

The applications 920 may utilize built in operating system functions (e.g., kernel 928, services 930 or drivers 932), libraries (e.g., system libraries 934, API libraries 936, and other libraries 938), and frameworks/middleware layer 918 to create user interfaces to interact with users of the system. Alternatively, or additionally, in some systems, interactions with a user may occur through a presentation layer, such as presentation layer 944. In these systems, the application/module “logic” can be separated from the aspects of the application/module that interact with a user.

Some software architectures utilize virtual machines. In the example of FIG. 9, this is illustrated by virtual machine 948. A virtual machine creates a software environment where applications/modules can execute as if they were executing on a hardware computing device. A virtual machine is hosted by a host operating system (operating system 914) and typically, although not always, has a virtual machine monitor 946, which manages the operation of the virtual machine as well as the interface with the host operating system (e.g., operating system 914). A software architecture executes within the virtual machine 948 such as an operating system 950, libraries 952, frameworks/middleware 954, applications 956 or presentation layer 958. These layers of software architecture executing within the virtual machine 948 can be the same as corresponding layers previously described or may be different.

### Modules, Components and Logic

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client, or server computer system) or one or more hardware processors may be configured by software (e.g., an application or application portion) as a hardware-implemented module that operates to perform certain operations as described herein.

In various examples, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner or to perform certain operations described herein. Considering examples in which hardware-implemented modules are temporarily configured (e.g., programmed), each of the hardware-implemented modules need not be configured or instantiated at any one instance in time. For example, where the hardware-implemented modules comprise, a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some examples, the processor or processors may be located in a single location (e.g., within a home environment, an office environment, or a server farm), while in other examples the processors may be distributed across a number of locations.

The one or more processors may also operate to support performance of the relevant operations in a “cloud computing” environment or as a “software as a service (SaaS).” For example, at least some of the operations may be performed by a group of computers (as examples of machines including processors), these operations being accessible via a network (e.g., the Internet) and via one or more appropriate interfaces (e.g., APIs).

### Electronic Apparatus and System

Examples may be implemented in digital electronic circuitry, or in computer hardware, firmware, or software, or in combinations of them. Examples may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In examples, operations may be performed by one or more programmable processors executing a computer program to perform functions by operating on input data and generating output. Method operations can also be performed by, and apparatus of some examples may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various examples.

### Example Machine Architecture and Machine-Readable Medium

FIG. 10 is a block diagram of a machine in the example form of a computer system 1000 within which instructions 1024 may be executed for causing the machine to perform any one or more of the methodologies discussed herein. In alternative examples, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a GPU, or both), a main memory 1004, and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard or a touch-sensitive display screen), a UI navigation (or cursor control) device 1014 (e.g., a mouse), a storage unit 1016, a signal generation device 1018 (e.g., a speaker), and a network interface device 1020.

### Machine-Readable Medium

The storage unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 or within the processor 1002 during execution thereof by the computer system 1000, with the main memory 1004 and the processor 1002 also each constituting a machine-readable medium 1022.

While the machine-readable medium 1022 is shown in accordance with some examples to be a single medium, the term “machine-readable medium” may include a single medium or multiple media (e.g., a centralized or distributed database, or associated caches and servers) that store the one or more instructions 1024 or data structures. The term “machine-readable medium” shall also be taken to include any tangible medium that is capable of storing, encoding, or carrying instructions 1024 for execution by the machine and that cause the machine to perform any one or more of the methodologies of the present disclosure, or that is capable of storing, encoding, or carrying data structures utilized by or associated with such instructions 1024. The term “machine-readable medium” shall accordingly be taken to include, but not be limited to, solid-state memories, and optical and magnetic media. Specific examples of a machine-readable medium 1022 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding, or carrying instructions 1024 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the inventive subject matter may be referred to herein, individually or collectively, by the “example” merely for convenience and without intending to voluntarily limit the scope of this application to any single example or concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

What is claimed is:

1. A system comprising:
a memory that stores instructions; and
one or more processors configured by the instructions to perform operations comprising:
enriching first user data of a food establishment to obtain a first input data set, the first user data comprising a sequence of first data points for an observed period, each first data point comprising an observed value of a target variable and a value of each of a plurality of establishment input features, the target variable being related to a food item, and the first user data being enriched, for each first data point, using values of a plurality of complementary features corresponding to the first data point;
enriching second user data of the food establishment to obtain a second input data set, the second user data comprising a second data point for a prediction period, the second data point comprising a value of each of the establishment input features, and the second user data being enriched using values of the plurality of complementary features corresponding to the second data point;
generating, by a multi-input machine learning model, a predicted value of the target variable for the prediction period, the multi-input machine learning model comprising a first component that processes the first input data set and a second component that processes the second input data set; and
causing presentation, at a user device associated with the food establishment, of output data including the predicted value of the target variable.

2. The system of claim 1, wherein the multi-input machine learning model comprises a parallel input machine learning model in which the first component and the second component separately process the first input data set and the second input data set, respectively, and in which outputs of the first component and the second component are combined to generate the predicted value of the target variable.

3. The system of claim 2, wherein first output of the first component and second output of the second component are concatenated to obtain a concatenated vector, and wherein the concatenated vector is processed by a third component to generate the predicted value of the target variable.

4. The system of claim 2, wherein the first component comprises a Recurrent Neural Network (RNN) and the second component comprises a feedforward network.

5. The system of claim 4, wherein the RNN comprises one or more long short-term memory (LSTM) layers, and wherein the feedforward network comprises one or more dense layers.

6. The system of claim 1, wherein the prediction period is a first prediction period and the predicted value of the target variable is a first predicted value, the operations further comprising:
automatically providing the first predicted value as input to the multi-input machine learning model to generate a second predicted value for a second prediction period that follows the first prediction period.

7. The system of claim 1, wherein the multi-input machine learning model is trained on a linked sequence of training data sets, each training data set in the sequence of training data sets comprising training data covering a respective training data period.

8. The system of claim 7, the operations further comprising:
enriching third user data of the food establishment to obtain an additional training data set, the third user data comprising a sequence of third data points for an additional training data period, each third data point comprising an observed value of the target variable and a value of each of the establishment input features, and the third user data being enriched, for each third data point, using values of the complementary features corresponding to the third data point;
linking the additional training data set to the sequence of training data sets to obtain an updated sequence of training data sets; and
storing the updated sequence of training data sets.

9. The system of claim 8, the operations further comprising:
retraining the multi-input machine learning model on the updated sequence of training data sets.

10. The system of claim 8, wherein each training data set is identified by a training data identifier, the operations further comprising:
receiving a user selection of a training data identifier;
generating a modified sequence of training data sets that commences at the training data set corresponding to the user selection and ends at the additional training data set; and
retraining the multi-input machine learning model on the modified sequence of training data sets.

11. The system of claim 1, wherein enriching the first user data comprises invoking an auto-enrichment function of an online data aggregator component.

12. The system of claim 1, wherein the target variable is a number of food items sold by the food establishment.

13. The system of claim 1, wherein the establishment input features comprise one or more of: date; holiday data; weather data; temperature data; humidity data; establishment type; cuisine type; delivery type; parking availability; establishment geographic area; establishment geographic area income level; establishment rating; peak time; food item price; food item category; or promotion data.

14. The system of claim 1, wherein the complementary features comprise one or more of: competitor data; online trend data; web search data; location data; or social media data.

15. A method comprising:
enriching first user data of a food establishment to obtain a first input data set, the first user data comprising a sequence of first data points for an observed period, each first data point comprising an observed value of a target variable and a value of each of a plurality of establishment input features, the target variable being related to a food item, and the first user data being enriched, for each first data point, using values of a plurality of complementary features corresponding to the first data point;
enriching second user data of the food establishment to obtain a second input data set, the second user data comprising a second data point for a prediction period, the second data point comprising a value of each of the establishment input features, and the second user data being enriched using values of the plurality of complementary features corresponding to the second data point;
generating, by a multi-input machine learning model, a predicted value of the target variable for the prediction period, the multi-input machine learning model comprising a first component that processes the first input data set and a second component that processes the second input data set; and
causing presentation, at a user device associated with the food establishment, of output data including the predicted value of the target variable.

16. The method of claim 15, wherein the multi-input machine learning model comprises a parallel input machine learning model in which the first component and the second component separately process the first input data set and the second input data set, respectively, and in which outputs of the first component and the second component are combined to generate the predicted value of the target variable.

17. The method of claim 16, further comprising:
enriching third user data of the food establishment to obtain an additional training data set, the third user data comprising a sequence of third data points for an additional training data period, each third data point comprising an observed value of the target variable and a value of each of the establishment input features, and the third user data being enriched, for each third data point, using values of the complementary features corresponding to the third data point;
linking the additional training data set to the sequence of training data sets to obtain an updated sequence of training data sets; and
storing the updated sequence of training data sets.

18. A non-transitory computer-readable medium that stores instructions that, when executed by one or more processors, cause the one or more processors to perform operations comprising:
enriching first user data of a food establishment to obtain a first input data set, the first user data comprising a sequence of first data points for an observed period, each first data point comprising an observed value of a target variable and a value of each of a plurality of establishment input features, the target variable being related to a food item, and the first user data being enriched, for each first data point, using values of a plurality of complementary features corresponding to the first data point;
enriching second user data of the food establishment to obtain a second input data set, the second user data comprising a second data point for a prediction period, the second data point comprising a value of each of the establishment input features, and the second user data being enriched using values of the plurality of complementary features corresponding to the second data point;
generating, by a multi-input machine learning model, a predicted value of the target variable for the prediction period, the multi-input machine learning model comprising a first component that processes the first input data set and a second component that processes the second input data set; and
causing presentation, at a user device associated with the food establishment, of output data including the predicted value of the target variable.

19. The non-transitory computer-readable medium of claim 18, wherein the multi-input machine learning model comprises a parallel input machine learning model in which the first component and the second component separately process the first input data set and the second input data set, respectively, and in which outputs of the first component and the second 1 component are combined to generate the predicted value of the target variable.

20. The non-transitory computer-readable medium of claim 19, the operations further comprising:
enriching third user data of the food establishment to obtain an additional training data set, the third user data comprising a sequence of third data points for an additional training data period, each third data point comprising an observed value of the target variable and a value of each of the establishment input features, and the third user data being enriched, for each third data point, using values of the complementary features corresponding to the third data point;
linking the additional training data set to the sequence of training data sets to obtain an updated sequence of training data sets; and
storing the updated sequence of training data sets.
